(19) United States
(12) Patent Application Publication
(10) Pub. No.: US 2013/0243932 A1
(43) Pub. Date: Sep. 19, 2013

(54) MEAT PRODUCT

(71) Applicants: Ann Waylan Brackenridge, London (CA); Thomas Richard Katen, Willshire, OH (US); Joseph L. Klemaszewski, Plymoutn, MN (US); Donald Andrew Moss, Park City, KS (US)

(72) Inventors: Ann Waylan Brackenridge, London (CA); Thomas Richard Katen, Willshire, OH (US); Joseph L. Klemaszewski, Plymoutn, MN (US); Donald Andrew Moss, Park City, KS (US)

(73) Assignee: CARGILL INCORPORATED, Wayzata, MN (US)

(21) Appl. No.: 13/989,350

(22) PCT Filed: Nov. 30, 2011
(86) PCT No.: PCT/US11/62545

§ 371 Date: May 23, 2013

Related U.S. Application Data
(60) Provisional application No. 61/418,673, filed on Dec. 1, 2010.

(51) Int. Cl. A23L 1/314

(52) U.S. Cl. CPC A23L 1/31454
USPC 426/644; 426/641

(57) ABSTRACT

A meat product is disclosed. A meat is blended with a starch, hydrocolloid, and an oil from a vegetable source. The resulting product is a product with reduced animal fat that maintains the sensory attributes of a full-fat product.

### FIELD

The present disclosure relates generally to a meat product. Aspects of the disclosure are particularly directed to a meat product consisting of meat, starch(es), hydrocolloid(s), and oil(s) from a vegetable source(s).

### BACKGROUND

Meat is defined as those animal tissues that are suitable for food, and includes all processed or manufactured products that are prepared from these tissues. The largest category of meat, in terms of volumes of consumption, is “red” meat. Beef, pork, lamb and veal are commonly identified as “red” meats. Horse, goat, eland, llama, camel, water buffalo and rabbit are also used for human consumption in many countries, and also fall within the red meat category.

Poultry meat is the flesh of domestic birds, and includes that of chickens, turkeys, ducks, geese, and guinea fowl. Game meat consists of the flesh of any non-domesticated animal. Seafood is also a category of meat and is the flesh of aquatic organisms.

Meat is composed of numerous tissues, such as adipose, epithelial, connective and nervous tissues, muscle and other fats. With regard to red meat, especially beef and pork meats, a high distribution rate of fat tends to be preferred. In order to obtain this distribution, beef cattle, horse, pigs and similar animals are fed not only a high calorie feed, but also additional ingredients to increase the fat components. With regard to poultry, the level and control of fat is adjusted by modifying diet.

Fat plays a vital role in a variety of sensory attributes, including juiciness, mouth feel and flavor. When a meat product has lower amounts of fat, there is a tendency for the cooked product to be less desirable in regards to juiciness, mouth feel and flavor. On the contrary, when a meat product has an optimal amount of fat, it is more desirable in terms of juiciness, mouth feel and flavor.

Processed meat products are defined as those products in which properties of fresh meat have been modified using one or more procedures, such as grinding or chopping, addition of seasonings or other ingredients, alteration of color or heat treatment. These modifications contribute to the preservation, convenience, appearance, palatability, variety and safety giving consumers a wide choice of meat products.

Processed meat products would be a model system for the application of functional fats. A functional food ingredient is defined as an ingredient or food that provides potential health benefits beyond basic nutrition. These functional components can be naturally occurring or may be added to certain foods. Such ingredients include but are not limited to Omega-3 fatty acids, antioxidants, phytosterols and dietary fibers. The functional fat system would serve as a delivery medium to deliver functional ingredients into processed meat products.

One example is sausage products. Sausage products may contain up to 30% fat. By utilizing leaner meats and substituting the animal based fats with functions fat the result is a sausage that would score higher in regards to health without sacrificing texture or flavor.

### SUMMARY

This invention allows for the production of a leaner meat product by decreasing the animal fat inclusion and total fat content in a comminuted meat system without sacrificing sensory attributes. There is a nutritional/sensory interaction which allows for the addition of a meat modifying agent to an already lean product which minimally impacts the lipid profile while increasing the sensory attributes of the product. Conversely, this will allow for the ability to take in the existing high fat product, remove the animal fat and replace it with a meat modifying agent to significantly impact the lipid profile while minimally impacting the sensory attributes of the product.

One embodiment of this invention is directed toward a meat composition comprising a meat, a starch, a gum and an oil from a non-animal source.

### DETAILED DESCRIPTION

The present invention will now be described in more detail.

The meat composition of the present invention comprises (A) meat, (B) starch(es), (C) hydrocolloid(s), and (D) oil(s) from a vegetable source(s).

Component A: Meat. The meat composition includes a meat. This meat can be from one or more source including red meat, poultry, game meat and seafood. Meat is comprised of numerous tissues, with muscle being the majority of the composition. Muscle is classified as red or white. This classification is based primarily on the proportion of red and white fibers. Thus, red muscles have a greater number of red muscle fibers and white muscles have a greater number of white muscle fibers. The red color is attributed to the higher myoglobin content of red fibers. In some muscles the color classification is not visible. However turkey and chicken breast is an example of a white muscle with a relatively high proportion of white fibers, with the contrary in turkey or chicken leg muscles being classified as red muscles. Muscle is additionally classified on the level of ATPase activity and how fast the fibers contract when stimulated.

The term “further processed” is commonly used to describe products that have had one or more of the following applied to the raw meat, grinding or chopping, addition of seasonings, alteration of color, or heat treatment. Comminution is the process of reducing particle size. Grinding is the most common process applied to meat to process whole muscle into ground products such as ground turkey, chicken, beef or pork. Dependent on the desired product, the particle size reduction varies from coarse to fine. The main advantages of grinding is to produce an uniform particle size and an increase in tenderness.

Component B: Starch. Starch is a carbohydrate polymer. Starches are comprised of amylose and amylopectin and are typically in the form of granules. Amylopectin is the major component (about 70-80%) of most starches. It is found in the outer portion of starch granules and is a branched polymer of several thousand to several hundred thousand glucose units. Amylose is the minor component (about 20-30%) of most starches (there are high amylose starches with 50 to 70% amylose). It is found in the inner portion of starch granules and is a linear glucose polymer of several hundred to several thousand glucose units.

Sources of starch include but are not limited to fruits, seeds, and rhizomes or tubers of plants. Common sources of starch include but are not limited to rice, wheat, corn, potatoes, tapioca, arrowroot, buckwheat, banana, barley, cassava, kudzu, oca, sago, sorghum, sweet potatoes, taro and yams. Edible beans, such as favas, lentils and peas, are also rich in starch.

Some starches are classified as waxy starches. A waxy starch contains high amounts of amylopectin with very little amylose. Common waxy starches include waxy maize starch, waxy rice starch, and waxy wheat starch.

A modified starch is one that has been altered from its native state, resulting in modification of one or more of its chemical or physical properties. Starches may be modified, for example, by enzymes, oxidation or, substitution with various compounds. Starches can be modified to increase stability against heat, acids, or freezing, improved texture, increase or decrease viscosity, increase or decrease gelatinization times, and increase or decrease solubility, among others. Modified starches may be partially or completely degraded into shorter chains or glucose molecules. Amylopectin may be debranched. Starches that are modified by substitution have a different chemical composition. A nOSA starch is a modified starch that has been partially substituted with n-octenyl succinic anhydride.

Component C: Hydrocolloid. Hydrocolloids are a family of long chain water soluble polysaccharides and are generally carbohydrate based which affect the viscosity/gelling of aqueous solutions. Common examples are locust bean gum, carrageenan (seaweed extract), guar gum, xanthan gum, gellan gum, scleroglucan, agar, pectin, alginate, cellulose derivatives, and gum acacia. These are broadly classified as gums. Starches and gelatin are sometimes characterized as hydrocolloids. One skilled in the art can use combinations of starches, gelatin, and gums to achieve desired texture and melt properties.

Component D: Oil from vegetable source(s): A lipid material composed of a mixture of generally triacylglycerides from non-animal sources such as soya, olive, rapeseed, avocado, palm, palm kernel, coconut, cocoa, peanut, corn, flax, sunflower, safflower, and cottonseed. These lipids may be solid or liquid at room temperature depending on the chain lengths of the fatty acids, degree of saturation, and method of hydrogenation. Oils from multiple sources may be combined or certain fractions removed by processing such as winterization.

One significant benefit of this invention is to replace the animal oils with oils that have a dietary functional use.

### EXAMPLES

Various products have been manufactured. Each comprises a fat mimetic and a meat. The examples below are merely illustrative and not limiting.

### Fat Mimetic Example 1

| | |
|---|---|
| Water | 40-60% |
| Non-hydrogenated palm oil | 15-30% |
| Low DE maltodextrin, (C*DryLight 01970) | 7-15% |
| Acid thinned nOSA starch, (EmCap ™ 06375) | 5-10% |
| Viscosifying nOSA starch, (DeliTex ™ 75320) | 3-8% |
| Kappa Carrageenan, (Satiagel ™ ME4) | 1-3% |
| Gelatin | 0-4% |
| Salt | 0-4% |
| Guar gum/xanthan gum | 0-3% |

All ingredients are compiled and then heated with agitation to 165 to 170° F. using a Blentech model CC-10 at low speed. Direct steam injection is quickest method, but other methods are possible. Product is hot filled and cooled. After refrigeration for a minimum of 24 hours the product can be ground, diced, grated, or shredded to desired size.

### Fat Mimetic Example 2

| | |
|---|---|
| Water | 40-60% |
| Non-hydrogenated palm oil | 15-30% |
| Acid thinned starch, (Cargill Set ™ 05033) | 7-15% |
| Acid thinned nOSA starch, (EmCap ™ 06375) | 4-10% |
| Viscoifying nOSA starch, (DeliTex ™ 75320) | 3-8% |
| Viscosifying starch, (MiraCleer ® 516) | 3-8% |
| Kappa Carrageenan, (Satiagel ™ RPT 8/60) | 1-3% |
| Gelatin | 2-5% |
| Salt | 0-4% |
| Guar gum/xanthan gum | 0-3% |

All ingredients are compiled and then heated with agitation to 165 to 170° F. using a Blentech model CC-10 at low speed. Direct steam injection is quickest method, but other methods possible. Product is hot filled and cooled. After refrigeration for a minimum of 24 hours the product can be ground, diced, grated, or shredded to desired size.

### Fat Mimetic Example 3

| Ingredient | Percentage |
|---|---|
| Water/ice | Balance |
| Palm shortening | 15-50% |
| Instant acid thinned nOSA starch | 8-15% |
| (EmCap ™ 12639) | |
| Low DE maltodextrin (C*DryLight 01970) | 7-14% |
| Instant viscosifying starch (HiForm ™ 12744) | 4-10% |
| Salt | 1-3% |
| Xanthan/guar gum | 0-2% |
| Citric acid | 0-2% |

Preblend all powders. Place shortening in bowl chopper and begin mixing. Add powders and disperse in the lipid phase. Add water and continue mixing until uniform consistency. Vacuum package and refrigerate for 24 hours to allow to knit.

### Fat Mimetic Example 4

### With Omega 3 Fatty Acids and Fibers

| Ingredient | Percentage |
|---|---|
| Water/ice | Balance |
| Palm shortening | 10-45% |
| Instant acid thinned nOSA starch | 8-15% |
| (EmCap ™ 12639) | |
| Inulin/soluble fiber source | 5-20% |
| Instant viscosifying starch (HiForm ™ 12744) | 4-10% |
| Omega-3 fatty acid source e.g. fish oil | 4-10% |
| Salt | 1-3% |
| Xanthan/guar gum | 0-2% |
| Citric acid | 0-2% |
| Antioxidants | As needed |

Preblend all powders. Place shortening and oil in bowl chopper and begin mixing. Add powders and disperse in the lipid phase. Add water and continue mixing until uniform consistency. Vacuum package and refrigerate for 24 hours to allow to knit.

### Meat Products

### Meat Product Example 1

### Pork Sausage

| | |
|---|---|
| Pork, 70% lean | 29.4% |
| Pork, ham chunks, <5% fat | 53.9% |
| Fat mimetic, example 2 | 14.7% |
| Salt and seasonings | 2.0% |

Sausages are stuffed in casings, frozen, than sliced to approximately ¾″ thick patties. Compared to a 30% fat control, example 5 was a firm chewy texture. The reduced fat product appeared to shrink less than a full fat control when both were cooked. Upon eating, the reduced fat product was observed to be moister and less chewy than a control with the same fat level and no added fat mimetic.

### Meat Product Example 2

### Meatball

| | |
|---|---|
| Ground beef, 93% lean | 55.0% |
| Fat mimetic, example 1 | 20.0% |
| Water | 5.0% |
| Bread crumbs | 5.0% |
| Seasonings and salt | 7.5% |
| Soy flour | 4.0% |
| Parmesan cheese | 2.0% |
| Dextrose | 1.5% |

Ingredients were blended and for 5 to 10 minutes and formed into spheres weighing 55-60 grams. The meatballs were then baked at 350° F. until an internal temperature of 160 to 170° F. was reached. Fat was drained from the control meatballs. No fat cook out was observed in the reduced fat meatballs. Cooked yield was determined by weighing precook and postcook. Yield increased in the reduced fat meatballs to 85 to 90% vs. 75 to 80% in a full fat control. Sensory evaluation of the reduced fat meatballs showed them to be moister and less chewy than the a control produced at the same fat level but with no added fat mimetic. Higher (or stronger) spice impact was also observed in the reduced fat example.

### Meat Product Example 3

### Ground Turkey

| | |
|---|---|
| Turkey breast, 99% lean | 95.45% |
| Fat mimetic, example 2 | 4.55% |

Lean turkey breast meat is added to a blender with an antioxidant where it is mixed for 5 minutes for homogenous dispersion. Upon dispersion of the antioxidant the meat is chilled with CO2 until the meat is 33° F., once the meat has been chilled it is ground through a ⅛″ grinder plate. Ground breast meat is added to the blender with 4.55% fat mimetic (shredded, ground, pellet, crumbled) and seasonings are also added. Product is mixed for 1 minute or until product is homogonously incorporated. The ground mixture is then transferred to appropriate equipment for packaging into chubs, sausages, patties, loafs.

Sensory testing was completed to compare ground turkey control and ground turkey containing fat mimetic. Results showed improvement for flavor, juiciness, texture, and overall preference for the product containing the fat mimetic.

### Meat Product Example 4

### 50% Reduced Fat Hot Dog

| | |
|---|---|
| Beef, 30% fat, coarse ground | 62.7% |
| Beef, 10% fat, coarse ground | 4.3% |
| Fat mimetic, example 2 | 15.0% |
| Water | 9.3% |
| Salt | 2.05% |
| 36 DE corn syrup solids | 2.0% |
| PolarTex ™ 05732 modified starch | 1.5% |
| Spice blend | 1.5% |
| Dextrose | 1.0% |
| Sodium tripolyphosphate | 0.4% |
| 6.25% Sodium nitrite cure | 0.2% |
| Sodium erythorbate | 0.05% |

Formulated fat content prior to smoke house = 11%
Fat content after smoking, 12.5% assuming 12% yield loss

Lean and fatty meats are coarse ground separately with a ⅜″ plate. Ground lean meats are placed in a bowl chopper and chopped at low speed. Half of water/ice is then added to chopper along with salt, phosphates, cure and erythorbate and chopped at low speed for two minutes. Fatty meats are added next and chopped for two minutes. Remaining ingredients are added and chopped at high speed until temperature of 60-62° F. is obtained. Higher temperatures may be needed for lower fat products. The product is then vacuumized and stuffed into 28 mm peelable casing. The hot dogs are then dipped in liquid smoke or naturally smoked followed by cooking to an internal temperature of 160-165° F. After cooking the hot dogs are then cooled to 35° F., peeled, washed, dried, and packaged.

1. A meat composition comprising:
Meat,
0.5-10% by weight of starch,
0.02-2% by weight of hydrocolloid, and
0.5-10% by weight of vegetable oil.

2. The meat composition of claim 1 where the meat is selected from the group consisting of one or more of beef, pork, lamb, veal, ostrich and poultry.

3. The meat composition of claim 2 where the poultry is selected from the group consisting of chicken or turkey or both.

4. The meat composition of claim 1 when the starch is selected from the group consisting of modified corn starches, modified tapioca starches, modified potato starches, modified rice starches, modified wheat starches, and modified sago starches.

5. The meat composition of claim 1 where the hydrocolloid is selected from the group consisting of one or more of locust bean gum, carrageenan (seaweed extract), guar gum, xanthan gum, gellan gum, scleroglucan, agar, pectin, alginate, cellulose derivatives, gum acacia, and gelatin.

6. The meat composition of claim 1 where the vegetable oil is selected from the group consisting of one or more of soya, olive, canola, avocado, palm, palm kernel, coconut, cocoa, peanut, corn, flax, sunflower, safflower, and cottonseed.

7. The meat composition of claim 1 where the amount of meat is not less than 70% by weight.

8. The meat composition of claim 1 where the amount of meat is not less than 75% by weight.

9. The meat composition of claim 1 where the amount of meat is not less than 85% by weight.

10. The meat composition of claim 1 where the amount of meat is not less than 90% by weight.

11. The meat composition of claim 1 where the amount of meat is not less than 95% by weight.

12. The meat composition of claim 1 where the amount of meat is not less than 99% by weight.

13. The meat composition of claim 1 where the concentration of starch is between 0.5% and 7.0% by weight.

14. The meat composition of claim 1 where the concentration of starch is between 0.5% and 5.0% by weight.

15. The meat composition of claim 1 where the concentration of hydrocolloid is between 0.05% and 1.0% by weight.

16. The meat composition of claim 1 where the concentration of gum is between 0.1% and 0.5% by weight.

17. The meat composition of claim 1 where the concentration of vegetable oil is between 1% and 7% by weight.

18. The meat composition of claim 1 where the concentration of vegetable oil is between 1% and 5% by weight.

19. The meat composition of claim 1 where the product is a form of loafs, chubs, patties, crumbles, or links.

20. The meat composition of claim 1 where the product has been extruded.

21. The meat product of claim 1 where the product has been cooked and is in the form of crumbles, links, patties, or roasts.
